(19) United States
(12) Patent Application Publication
(10) Pub. No.: US 2016/0325739 A1
(43) Pub. Date: Nov. 10, 2016

(54) APPARATUS AND METHOD FOR CONTROL AND BALANCE ASSIST OF A VEHICLE

(71) Applicant: MTS Systems Corporation, Eden Prairie, MN (US)

(72) Inventors: Bradley C. Litz, Chaska, MN (US); Craig R. Shankwitz, Minneapolis, MN (US)

(21) Appl. No.: 15/095,960

(22) Filed: Apr. 11, 2016

Related U.S. Application Data
(63) Continuation-in-part of application No. 13/841,408, filed on Mar. 15, 2013, now Pat. No. 9,310,808.
(60) Provisional application No. 62/296,342, filed on Feb. 17, 2016.

(51) Int. Cl. B60W 30/04

(52) U.S. Cl. CPC B60W 30/04; B60W 2030/043; B60W 2520/18; B60W 2720/28; B60W 2720/18

(57) ABSTRACT

A vehicle control system for use on a roll-unstable wheeled vehicle, such as a motorcycle or an all-terrain vehicle (ATV) to assist in control the vehicle. The vehicle control system comprises a moment generator coupleable to the vehicle and configured to selectively generate a moment in either of first and second directions. The vehicle control system also includes a control system operably coupled to the moment generator and configured to control the moment generator to selectively impart moments on the vehicle to stabilize the vehicle or to introduce disturbances on the vehicle.

### FIELD

Disclosed embodiments relate to durability and performance testing of motorcycles and other vehicles. More particularly, disclosed embodiments related to apparatus and methods of providing control of a vehicle in a manner which allows the control and balance of the vehicle to be supplemented for a human driver.

### BACKGROUND

Vehicles such as motorcycles and all-terrain vehicles (ATVs) frequently undergo performance or durability testing under harsh conditions. These conditions may include high or low temperatures, rough test courses, and long durations of continuous or nearly continuous operation of the vehicle. Frequently, these performance or durability tests are so extreme that they end up testing the driver of the vehicle more than they test the vehicle itself. For example, to properly warm up a motorcycle for such testing, it may be necessary for the driver to operate the motorcycle at slow speeds for a prolonged period of time. Since the rider will typically wear protective gear that limits cooling of the driver, and since such testing commonly takes place in desert or other warm weather locations, the test driver may only be able to endure this difficult test environment for a relatively small amount of time.

Due to the physical demands of driving a motorcycle during durability or performance testing, it is common for drivers to be able to work only a few hours before requiring rest. This can increase the costs of testing. Also, it is common for drivers of motorcycles during durability or performance testing to experience work related injuries as a result of the physical demands placed upon them. Often, motorcycle testing results in both short term and long term physical disabilities for test riders. In addition to human toll, these factors also add to the costs of testing. Further still, to adequately test electronic stability control systems or anti-lock brake systems on a motorcycle, ATV or similar vehicle, the driver may be put in significant danger, which may not be a plausible risk to incur.

To avoid the physical toll on test drivers and also to avoid the associated costs, testing such vehicles without a human driver would prove desirable in some instances. However, at very low speeds (e.g., speeds (e.g., less than ˜1 meter/second) motorcycles are very unstable, making any automated control of the motorcycle steering difficult. In this so-called “capsize mode” of operation, a human driver manipulates body position to stabilize the motorcycle. Without a human driver, such stabilization is very difficult using only steering inputs. Further, even at higher speeds (e.g., speeds greater than ˜1 meter/second), sometimes referred to as the “weave mode”, where the motorcycle is more stable due to due to its geometry, mass distribution, and gyroscope effect of the wheels, without a human driver it is difficult to test the motorcycle performance and durability in situations where a human driver would use body positioning to compensate during disturbances (e.g., wind gusts) and during normal turning, etc. The speed at which the transition from capsize to weave occurs is dependent on a vehicle mass, rake angle, wheelbase, etc.

The discussion above is merely provided for general background information and is not intended to be used as an aid in determining the scope of the claimed subject matter.

### SUMMARY

This Summary and Abstract is provided to introduce a selection of concepts in a simplified form that are further described below in the Detailed Description. The Summary and Abstract are not intended to identify key features or essential features of the claimed subject matter, nor is it intended to be used as an aid in determining the scope of the claimed subject matter.

In one embodiment, a vehicle control system for use on a roll-unstable wheeled vehicle includes a moment generator coupleable to the roll-unstable wheeled vehicle. The moment generator is configured to selectively generate a roll moment in either of first and second directions about a vehicle longitudinal axis corresponding to forward motion of the roll-unstable wheeled vehicle. The moment generator includes a reaction wheel and a motor configured to rotationally accelerate or decelerate the reaction wheel. A control system operably coupleable to the moment generator is configured to control the moment generator to selectively impart roll moments on the roll-unstable wheeled vehicle.

In other aspects, the control system may be used to stabilize the roll-unstable wheeled vehicle or to selectively introduce destabilizing disturbances on the vehicle. The motor includes a brake configured to selectively rotationally decelerate the reaction wheel and thereby selectively impart the roll moments on the roll-unstable wheeled vehicle. The motor may selectively rotationally accelerate or decelerate the reaction wheel in both of two directions, thereby selectively generating the roll moments in either of the two directions.

The moment generator may further include a second reaction wheel and a motor configured to rotationally accelerate or decelerate the second reaction wheel in a direction opposite the first reaction wheel, and wherein the control system is configured to control rotational acceleration or deceleration of both of the first and second reaction wheels to thereby selectively generate the roll moment in either of the first and second directions. The moment generator may also include an actuated pendulum to selectively generate the roll moment in either of the first and second directions, or a roll moment generator configured to impart the roll moment on the roll-unstable wheeled vehicle in the vehicle longitudinal axis, and a yaw moment generator configured to impart a yaw moment on the roll-unstable wheeled vehicle in a vehicle vertical axis.

The reaction wheel may be configured to be rotationally accelerated or decelerated about the vehicle longitudinal axis. The motor is configured to rotationally accelerate or decelerate the reaction wheel about the vehicle longitudinal axis. A support frame supports the reaction wheel and the motor. An actuator is configured to rotate the reaction wheel, the motor, and the support frame about the vehicle vertical axis, perpendicular to the vehicle longitudinal axis, wherein angular acceleration of the reaction wheel, the motor, and the support frame about the vehicle vertical axis imparts the yaw moment upon the roll-unstable wheeled vehicle about the vehicle vertical axis, and thereby the yaw moment generator comprises the reaction wheel, the motor, the support frame and the actuator.

The reaction wheel may be configured to be rotationally accelerated or decelerated about the vehicle longitudinal axis. The motor is configured to rotationally accelerate or decelerate the reaction wheel about the vehicle longitudinal axis. A lateral translation mechanism configured to move the reaction wheel laterally relative to the vehicle longitudinal axis to generate moments to compensate for persistent roll disturbances or non-uniform mass distributions about the vehicle vertical axis. The lateral translation mechanism includes in one aspect a fixed frame coupleable in a fixed position relative to the roll-unstable wheeled vehicle. A translation frame supports the reaction wheel, and an actuator is configured to move the translation frame and reaction wheel with respect to the fixed frame and laterally relative to the vehicle longitudinal axis.

The reaction wheel and the motor may be configured to rotationally accelerate or decelerate the reaction wheel. The control system may include an optimal controller configured to maintain the slowest rotational velocity of the reaction wheel in order to provide maximum torque availability from the motor for compensation of transient roll disturbances on the roll-unstable wheeled vehicle.

The moment generator in one aspect is configured to be coupled to a motorcycle frame to provide control of the motorcycle, and may be coupled to the frame behind the rider, behind the rider and a passenger, beneath the rider, or at other parts of the frame.

The moment generator in another aspect also includes a yaw moment generator controlled to selectively impart a yaw moment on the roll-unstable wheeled vehicle in a vehicle vertical axis to stabilize the roll-unstable wheeled vehicle or to introduce destabilizing disturbances on the roll-unstable wheeled vehicle.

The moment generator may be enabled when the roll-unstable wheeled vehicle has a zero speed in the forward direction, and disabled when the roll-unstable vehicle has a speed greater than zero, or above a selected forward speed, in the forward direction.

In another embodiment, a method of providing control assist of a roll-unstable wheeled vehicle includes accelerating or decelerating a reaction wheel coupled to the roll-unstable wheeled vehicle in either of first and second directions about a vehicle longitudinal axis corresponding to forward motion of the roll-unstable wheeled vehicle. The reaction wheel acceleration and deceleration is controlled to selectively impart roll moments on the roll-unstable wheeled vehicle relative to the vehicle longitudinal axis to stabilize the roll-unstable wheeled vehicle or to introduce destabilizing disturbances on the roll-unstable wheeled vehicle.

In yet another embodiment, a method of providing control assist to a roll-unstable wheeled vehicle operated by a driver includes accelerating or decelerating a reaction wheel coupled to the roll-unstable wheeled vehicle in either of first and second directions about a vehicle longitudinal axis corresponding to forward motion of the roll-unstable wheeled vehicle, and controlling the reaction wheel acceleration or deceleration to selectively impart roll moments on the roll-unstable wheeled vehicle relative to the vehicle longitudinal axis to stabilize the roll-unstable wheeled vehicle or to introduce destabilizing disturbances on the roll-unstable wheeled vehicle. Stabilizing moments are selectively imparted when the roll-unstable wheeled vehicle has a speed in the forward direction at or lower than a predetermined speed, and stabilizing moments are not imparted when the roll-unstable wheeled vehicle has a speed greater than the predetermined speed in the forward direction.

In still another embodiment, a motorcycle includes a frame having an engine, a pair of wheels, a seat, and handlebars mounted to the frame, and a moment control system mounted to the frame. The moment control system includes a moment generator coupled to the motorcycle and configured to selectively generate a roll moment in either of first and second directions about a motorcycle longitudinal axis corresponding to forward motion of the motorcycle, wherein the moment generator comprises a reaction wheel and a motor configured to rotationally accelerate or decelerate the reaction wheel, and a control system operably coupleable to the moment generator and configured to control the moment generator to selectively impart roll moments on the motorcycle to stabilize the roll-unstable wheeled vehicle or to selectively introduce destabilizing disturbances on the motorcycle.

### BRIEF DESCRIPTION OF THE DRAWINGS

FIG. 1 is a diagrammatic view of a roll-unstable wheeled vehicle with a control system in accordance with example embodiments.

FIGS. 2-1 and 2-2 are block diagram illustrations showing further details of example components of a control system.

FIGS. 3-1 through 3-3 are diagrammatic illustrations of various example embodiments of a moment generating system which can be used in a control system.

FIGS. 4-1, 4-2, 4-3 and 5 are illustrations of example embodiments of moment generation system embodiments which include lateral translation capability for laterally moving a reaction wheel.

FIG. 6 is a block diagram of a rider system in accordance with an exemplary embodiment.

FIG. 7 is a block diagram of a reaction wheel controller in accordance with an exemplary embodiment.

FIG. 8 is a block diagram of a control system in accordance with an exemplary embodiment.

FIGS. 9A-9G are diagrammatic views of a system for a driver-ridden roll-unstable wheeled vehicle according to an exemplary embodiment.

FIG. 10 is a diagrammatic view of operation of a control system according to another exemplary embodiment.

FIG. 11 is a block diagram of a controller and system according to an exemplary embodiment.

FIG. 12 is an image showing “hanging off” a motorcycle.

FIGS. 13-22 area diagrams accompanying the Appendix on motorcycle data flow and determinations.

### DETAILED DESCRIPTION OF ILLUSTRATIVE EMBODIMENTS

Disclosed embodiments facilitate assisting in the performance of roll-unstable wheeled vehicles, such as motorcycles, ATVs, or other vehicles that operate by introducing a roll moment on the vehicle during, for example, cornering, on test tracks or highways. The following description is provided with reference to motorcycles, but those of skill in the art will understand that the disclosed embodiments can be used, or adapted to be used, with these other vehicle types. With a system, driver assistance can occur during driving, or at stops of the vehicle, to assist in vehicle operational capability. In another embodiment, autonomous control of the motorcycle or the like can be provided.

As disclosed herein, reference will be made to operation of the system as generating moments or location of the system on the vehicle. Such references are particularly directed to the reaction wheel that generates such moments. It should be understood that such references do not mean that other aspects of the system of the complete system (e.g., controller, interfaces, sensors, and the like) need to be located in the location indicated.

The embodiments described herein facilitate actions which are beneficial for operational driving, and stationary operation (such as at a stop light or other stopped situation in which a rider remains on the vehicle). The embodiments use a system such as system 105 described below, but instead of the system 105 being autonomous on a vehicle with no rider, the system in the present embodiments is mounted to a vehicle such as a motorcycle in a configuration in which the rider is operating the vehicle, such as in normal operation, or in testing. The embodiments of the present disclosure may augment a roll moment imparted on a motorcycle by the human rider to improve roll performance of the motorcycle.

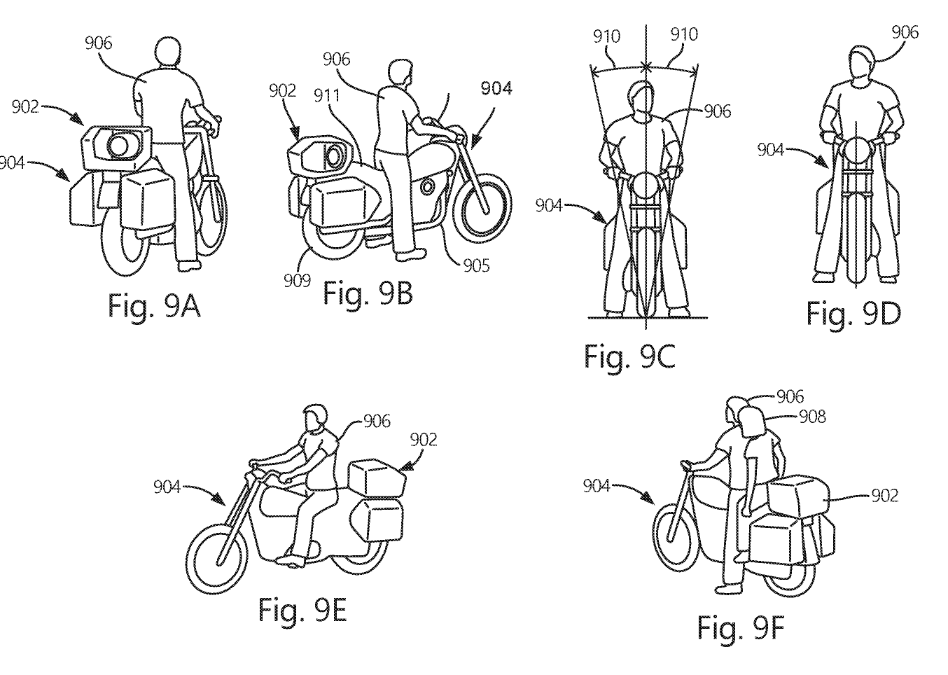

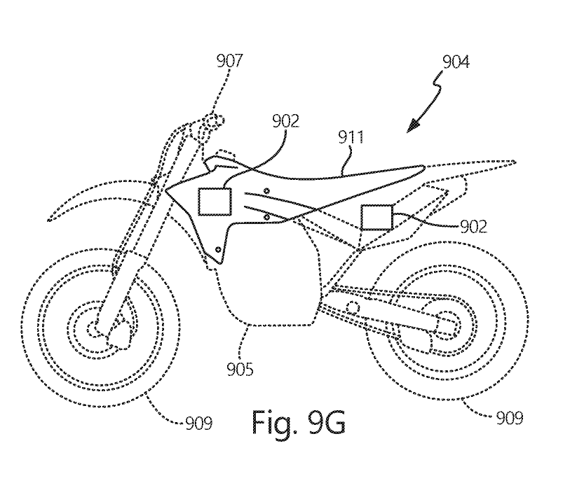

Upright roll stability augmentation using a system 902 configured to be mounted to a motorcycle 904 operated by a rider 906 is shown in FIGS. 9A-9F. In this example, the motorcycle roll augmentation system 902 provides or supplements a roll moment generated by a human rider 906 when upright positioning of the motorcycle 902 is desired such as when the motorcycle is stationary or moving at a slow speed in a preferred embodiment when the motorcycle and rider are moving less than about 3 miles per hour, and in particularly advantageous situation when the motorcycle and rider are moving less than about 1 mile per hour. As indicated above, the roll stabilization augmentation system 902 helps a rider 906 maintain the motorcycle 904 in its upright, vertical position. The system 902 operates by sensing a motorcycle roll angle (see FIG. 9C), and the motorcycle roll rate, and imparts a roll moment (such as shown at arrows 910) to impart a roll moment sufficient to retain the motorcycle in an upright position, or supplement the roll moment provided by the human rider 906 such as through the rider's arms and legs. The system 902 allows a motorcycle 904 to be maintained in a stable vertical position even on inclines, such as that shown in FIG. 9D.

The system 902 can be used by a rider who desires additional steadiness assistance while the motorcycle is at a standstill or moving slowly. A balancing reaction moment from the system 902 is selectively transferred to the motorcycle 904 when the system is active. In one embodiment, when the motorcycle 904 is at a stop, the system 902 is enabled to assist the rider 906 in keeping the motorcycle 904 upright. The system 902 can keep the motorcycle 904 vertical even on an incline. When the system 902 senses forward movement, or movement greater than a selected speed, of the motorcycle 904 in one embodiment, the system 902 is disabled. The system 902, and in particular, a reaction wheel, is in one embodiment sized to fit inside a pack that is capable of being mounted, for instance in a removable manner, on the motorcycle frame, such as, but not limited to, a luggage rack. Alternate positions of the system 902, at least the reaction wheel, are shown in schematic form in FIG. 9G below and/or behind the operator, or in front og th and/or below the operator. When a passenger is on the motorcycle, the system can assist in compensation for shifting movement of the passenger.

Maintaining a stable operating condition includes, in one embodiment, any stable operation of the motorcycle. For example, in normal forward operation in a straight line, or at a standstill, a stable operating condition is substantially upright. However, when in a turn, a stable operating condition is in a position in which the sum of moments about the roll axis is zero, such as in a motorcycle configuration as shown in FIG. 10 or 12. In that operating condition, the motorcycle is in a stable operating condition even though it is leaning, because the forces exerted on the motorcycle balance one another to maintain it in a stable operating condition through the corner.

System 902 is particularly helpful for a rider of diminished, reduced, or slight strength that wishes to ride a motorcycle where depending upon the capacity of the rider, maintaining stability in a stationary position may be difficult. One rider application is an older rider whose leg strength is diminished by age, disease, injury, etc. Another is when a passenger 908 (FIG. 9F) is present on the motorcycle 904. The system 902 can operate in this embodiment to compensate for or counteract shifting weight of a passenger that can occur without notice to the rider 906 and could otherwise without system 902 contribute to the motorcycle 902 falling over or otherwise cause difficulties for the rider 906.

If the rider 906 is unable to adequately support the motorcycle 904 at zero or slow speeds, the rider 906 is likely to accidently let the motorcycle become unbalanced, and potentially drop the motorcycle 904, which can cause damage to the motorcycle 904, and potentially serious injury to a rider 906 and/or passenger 908. In the embodiment described in FIGS. 9A-9F, if the motorcycle 904 begins to fall, the system 902 imparts a restorative roll moment to the motorcycle 904, impeding its fall. Operation of the system 902 is as described below with respect to system 105 in one embodiment, with the system 902 mounted in a position on the motorcycle 904 such that a human rider 906 is in general control of the motorcycle, with the system 902 used while the motorcycle 904 is stationary. In the embodiment illustrated, system 902 is located behind the rider 906 above a rear wheel of the motorcycle 904. This location is commonly used for storing luggage and the like. The system 902 can be configured to be removably mounted to the motorcycle 904 such as but not limited to a carrying rack that is sometimes provided on the motorcycle 904. However, location behind the rider 906 and/or rider 908 is not the only location. Other locations can be below the rider 906 attached to the frame such as behind the engine, but again, this should not be considered limiting. Since the system generates a pure roll moment, the reaction wheel can therefore be mounted at any location on the roll-unstable wheeled vehicle, as long as the axis on which the reaction wheel spins is parallel to the longitudinal axis of the roll-unstable vehicle. Further, when embodiments of the system are used in which a rider is in control of the vehicle, the system is mounted in a position on the vehicle so as to allow the rider to be seated on the vehicle in a normal operating position.

A motorcycle 904 according to one embodiment of the disclosure includes a frame 905, handlebars 907, wheels 909, a seat 911 between the wheels for a rider 906 to sit on, and a roll augmentation system 902 mounted to the motorcycle 904. As shown in FIGS. 9A-9F, the system 902 is mounted behind the seat 911 and the rider 906 to emulate a passenger, or behind a passenger 908. Further, the system may be mounted below the rider However, it should be understood that the system 902 may be mounted in a different position as described further herein. It should further be understood that a motorcycle includes, by way of example only, and not by way of limitation, motor scooters and other powered two-wheeled vehicles, or other vehicles having more than two wheels that have a non-rigid frame which can have a non-vertical orientation through a roll angle, or in which a proper roll angle, other than vertical, is helpful in operation.

In the embodiments of FIGS. 9A-9F, the system 902 is operational when the motorcycle 904 is moving slowly and/or stationary. Another embodiment of use of a system such as system 902 is shown in FIG. 10 where transient roll augmentation is desired. In this situation, the system 902 supplements a roll moment generated by a rider 906 while in moving (faster) operation of the motorcycle 904 and in particular when it is desired to operate the motorcycle 904 while maintaining an angle of inclination of the motorcycle 904 rather than vertical operation of the motorcycle 904. This is accomplished in one embodiment by imparting additional roll moments in the direction of the roll moment imparted by the rider 906 on a rotating or inclined motorcycle 904. When a motorcycle rider 906 desires to turn a motorcycle 904, the rider undertakes at least one of several actions. The actions include applying a moment to the motorcycle handlebars, rotation of the rider torso in the direction of the desired turn, and shifting the weight of the rider 906 off a center line of the motorcycle (i.e., “hanging off” the motorcycle). For example, consider a motorcycle rider racing a motorcycle through a chicane. The motorcycle rider imparts roll moments on the motorcycle by

a. applying a moment to the handlebars,
b. rotating her torso in the direction of the corner, and
c. “hanging off” of the motorcycle (see FIG. 12).

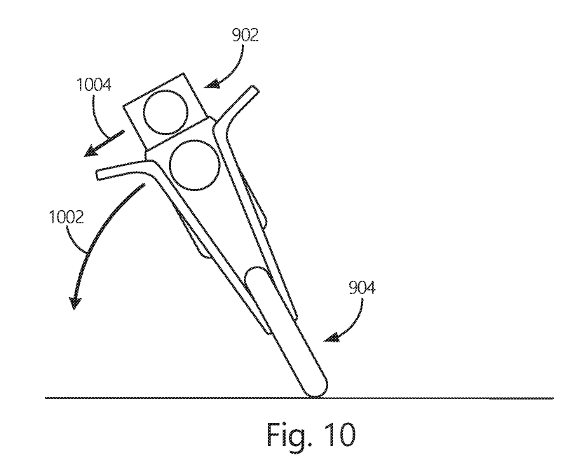

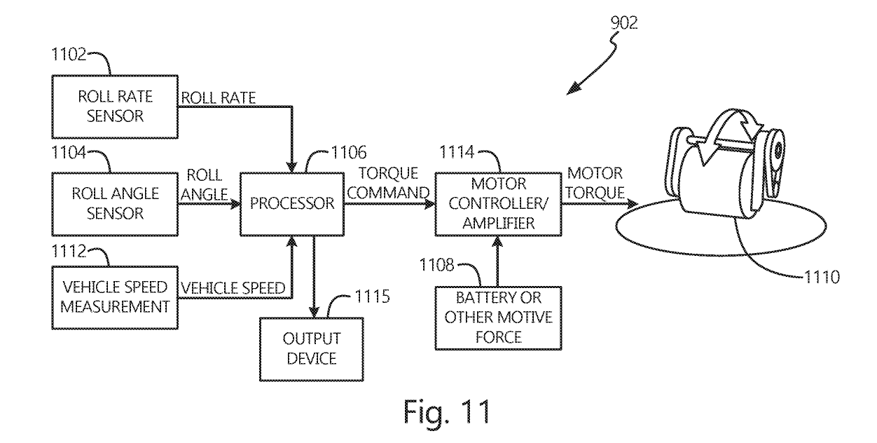

If the rider 906 is to improve the transition of the motorcycle 904 into or out of a corner, the system 902 in one embodiment assists by imparting a moment in the desired direction (as determined by roll and roll-rate sensors mounted on the motorcycle 906 as shown in greater detail in FIG. 11), which increases the net moment applied to the motorcycle-rider system. The additional moment provided by system 902 decreases the time required to achieve the desired roll angle of the motorcycle 904. By decreasing the time to achieve the desired roll angle, the motorcycle 904 can maintain a vertical orientation longer, allowing a rider 906 to initiate braking at a later time. By braking later, higher speeds can be maintained for a longer time, resulting in lower lap times in racing. Further, if a rider has low flexibility, or low weight, a weight shift or torso motion, which may be sufficient for a heavier rider to accomplish a turn without much moment on the handlebars, may be insufficient to accomplish the same turn, necessitating additional moment on the handlebars. Many turns, especially those accomplished at higher speeds but not in a race situation, are much easier to perform without much moment on the handlebars. A rider applying roll moment to the motorcycle by leaning his or her body into the turn reduces the amount of roll moment which is applied to the handlebars (and therefore the tire contact patch), reducing the force and moment loading of the tire and increasing the headroom the tire has to respond to other road and vehicle disturbances. An embodiment of the system 902 in which the system 902 adds to a roll moment such as described herein assists a low weight or low flexibility rider in performing turns without excessive handlebar motion, and is shown in FIG. 10. In FIG. 10, the motorcycle 904 is in a turning orientation in which the vehicle 904 is turning to its right. The roll moment exerted by the angular rotation of the vehicle 904 and its rider (not shown) is shown at 1002. When the system 902 of the embodiment of FIG. 10 is active, such as for a situation in which turning assistance is desired, the system 902 provides an additional moment 1004 in the direction of the angular rotation, as opposed to opposite the direction of the angular rotation which is described with respect to FIGS. 9A-9F.

The system 902 of FIGS. 9A-9F and FIG. 10 is illustrated in greater detail along with a control system in block diagram form in FIG. 11. In this embodiment, system 902 comprises a roll rate sensor 1102, a roll angle sensor 1104, a processor 1106, an electric (or other) motor 1108, and a reaction wheel 1110. The roll rate sensor 1102 provides a roll rate signal to the processor 1106. The roll angle sensor 1104 provides a roll angle signal to the processor 1106. A speed sensor 1112 provides a speed signal to the processor 1106. The processor provides a torque command based on the provided roll rate, roll angle, and vehicle speed to a motor controller 1114. The motor controller 1114 provides a motor torque signal to the reaction wheel 1110. Operation of the reaction wheel 1110 is similar to that of reaction wheel and control as described herein with respect to system 105.

When the motorcycle 904 is stopped or moving slowly as described above, and begins to tip laterally, the roll rate sensor 1102 determines a rate at which the motorcycle is falling. The roll angle sensor 1104 determines how far the motorcycle has tipped from a vertical orientation, and the speed sensor 1212 tells determines the vehicle speed. The signals indicative of the sensed vehicle speed, roll rate and roll angle allow the processor 1106 of the system 902 to determine the vehicle state and how it should act. For example, if the motorcycle 904 is moving slowly or stopped, the system determines a reaction sufficient to maintain a vertical orientation of the motorcycle. In this embodiment, the system 902 is active only when the vehicle speed is moving slowly or stopped.

In another embodiment, the system 902 is used to augment operation of the motorcycle 904, such as is situations in which the driver of the motorcycle 904 would be able to benefit from such assistance. Examples of such operation include those described above with respect to smaller or less flexible drivers. In this embodiment, if the vehicle is moving faster than a specified speed, the system 902 assists the driver in completing a turn by providing a roll moment not to return the motorcycle 904 to vertical orientation but rather to provide a non-vertical orientation to help position the motorcycle 904 in a proper inclination given the speed of the motorcycle 904 when taking the turn. This can take the form of reacting to increase the speed or angle of rotation. This is in one embodiment a moment induced by the reaction wheel in a direction so as to enhance the roll as opposed to countering it. The processor 1106 receives the signals from the sensors 1102, 1104 and 1112 and outputs the control signal to initiate rotation of the reaction wheel 1110 so as to obtain a desired configuration of the motorcycle 904 throughout the turn and providing additional roll moments as needed. If desired additional inputs to the processor 1106 can include a sensor monitoring the rotation of the handle bars.

In general, the vehicle, such as a motorcycle, in the various embodiments reacts against the acceleration of the reaction wheel, imparting the desired moment onto the motorcycle. In each embodiment, the amount of torque applied to impart the desired moment, either in the direction of the roll (as in FIG. 10), or in a direction opposite the direction of the roll (as in FIGS. 9A-9F) is proportional to both the roll angle and the roll rate as determined by the roll angle sensor 1104 and the roll rate sensor 1102.

Operation of the system 902 may be used for several different scenarios. For example, in normal operation of the motorcycle with a rider, the system 902 may be operational only at very low speeds or when the motorcycle is stopped, to assist in the maintenance of the motorcycle in an upright position where it is substantially vertically oriented. In normal operation of the motorcycle at speeds where the motorcycle is more traditionally stable, the system may be disabled. In normal operation when the motorcycle is entering or in a corner, the system 902 may be enabled as described herein to assist in the cornering operation by applying a moment either to enhance the roll or retard the roll of the motorcycle. This may be done to assist in turning by placing the motorcycle in a stable operating condition based on roll rates, roll angle, velocity, handlebar position, geometry of the motorcycle, the center of gravity of the rider and motorcycle, or any combination thereof. The stable operating position is one in which the moments imparted by the roll of the motorcycle and the force of the pavement on the motorcycle tires cancel. The system 902 is operated in one embodiment to add moment or to subtract moment to move the motorcycle and rider combination to a stable operating position. In this way, the system can assist a rider in making a turn where forces related to roll are neutral. Determination of the amount of moment to enhance or retard roll in a turning configuration of the motorcycle may be determined in another embodiment by the use of tables indicating stability parameters at various speeds, roll rate, roll angles, and the like.

The embodiments of the present disclosure may also be used in training of riders in a racing context, or in a training context for beginning or non-professional riders. For example, in one embodiment, a race rider may use a system such as system 902 on a track known to the system 902, from GPS measurements or the like, such as from a GPS system like system 215 described herein, in which the correct (or fastest) riding lines through the corners of the track are known. The system, having information of the configuration of the track, the motorcycle's position on the track, and its speed, can anticipate corners, and begin to apply moment suggesting what body movements the rider should be performing to prepare for proper cornering. When the rider enters a corner or is in a corner, and is not at the proper roll angle or center of gravity position, the system 902 in one embodiment provides an indication (e.g., visual or audible) from an output device 1115 (FIG. 11) of the operation status of the system, including whether the system is active, and/or further visual or audible indicators as described herein. For example, a visual indicator such as an arrow on a display of the motorcycle may indicate to a rider a desired direction for a shift in body mass, and may indicate a longer arrow for a higher amount of shift, and a shorter arrow for a smaller amount of shift. While one example of a visual indicator is described, it should be understood that additional types of visual indicators may be used without departing from the scope of the disclosure. Likewise, the system 902 can provide audible indications through speakers, for example in a rider's helmet, the speakers being operably coupled to the system, for example, wired or wirelessly.

In another embodiment, the system 902 can dynamically respond to predict a turn based upon changes in, for example, a position of a rider (as determined by at least one of a roll rate or roll angle) alone or in combination with changes in the position of the handlebars. Once turn has been predicted, the system 902 estimates a radius of curvature of the turn based on vehicle speed, roll angle, handlebar angle, motorcycle wheel base, and/or rake angle. From these inputs, the radius of curvature estimate allows a determination of a neutral angle for completing the turn. The system 902 can then operate in the manner described above to aid or train a rider in making the turn. This dynamic determination can be used in conjunction with position information obtained or known by a GPS system to further assist in the operation of the system 902.

Training in a non-professional rider context in one embodiment comprises the introduction, by the system 902, of destabilizing forces to simulate potential situations that a motorcycle operator may encounter during riding. Such destabilizing forces include, but are not limited to, forces introduced by the system 902 to replicate the shifting of a passenger, either during normal operation while moving in a substantially straight line, to replicate improper shifting of a passenger during cornering, to replicate a wind gust or wash from a passing vehicle, or the like. The introduction of such destabilizing forces in a training environment can allow a rider to learn to adjust properly when a destabilizing force is introduced by external forces or a passenger in normal riding.

In another embodiment, the system 902, or the reaction wheel thereof, may be activated even without the motorcycle engine running, to assist, for example, in the moving of the motorcycle, such as in a garage or parking lot. As motorcycles can be quite heavy, the ability of the system 902 to maintain the motorcycle in an upright orientation for such movements is beneficial. Another use for the activation of the system 902 is for loading and/or unloading of the motorcycle onto and/or off of a trailer or the like. Control assist of the motorcycle may be selectively turned on and off, manually, or automatically.

Further disclosed are a method and apparatus to provide a pure mechanical roll moment needed to stabilize a motorcycle at zero or low speeds (where the predominant instability mode is capsize) in the presence of roll disturbances and without the use of outriggers or other physically stabilizing mechanisms (i.e., “training wheels”). The use of outriggers and other mechanical stabilizing devices change the roll and yaw dynamics of the motorcycle, reducing the fidelity with which the durability and performance tests will be executed. Disclosed embodiments overcome this limitation of outriggers.

Additional, disclosed methods and apparatus provide both pure roll and (optionally) yaw moments to vehicles operating in the “weave” operational mode (e.g., speeds greater than ˜1 meter/second) where the motorcycle is comparatively more stable than the capsize mode of operation. In the “weave” mode, speeds are sufficiently high so that the motorcycle, without a rider, is marginally stable. In this mode, a marginally stable motorcycle will balance and travel without a rider for a time period, but will eventually become unstable, weave and crash. In the marginally stable, weave mode regime, a stabilizing feedback controller was designed which provides roll control and stability through steering inputs. Using steering to stabilize and control the motorcycle frees the disclosed embodiments to impart both a pure roll moment (simulating a motorcycle rider's rotation of the upper body in the roll axis) and/or a pure yaw moment (simulating the rotation of a motorcycle rider's upper body in the yaw axis) to the motorcycle, offering a repeatable means by which the motorcycle under test can be exposed to particular simulated rider roll and yaw behaviors. Repeatability is important for both durability and performance testing.

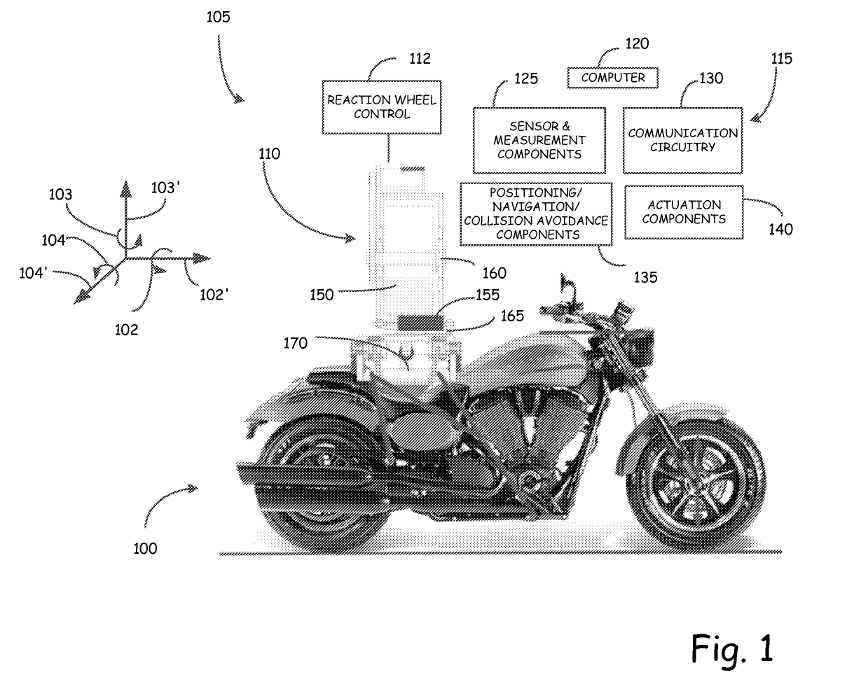

Referring now to FIG. 1, shown is a motorcycle 100 having an autonomous control system 105 installed which allows motorcycle 100 to undergo performance and/or durability testing without the need for a human driver. Autonomous control system 105 includes a moment generating system 110 and a navigation and control system 115. Navigation and control system 115 includes numerous subsystems and components which are described below. The components of navigation and control system 115 can work with moment generating system 110 and, in some embodiments, can be considered to be included in moment generating system 110. Further, the illustrated components of system 115 need not all be included in every embodiment. For illustrative and discussion purposes, the components of navigation and control system 115 are categorized here as computer related components 120, sensor & measurement components 125, communication circuitry 130, positioning, navigation & collision avoidance components 135, and actuation components 140. These components control position determination, communication with a base or control station or with other autonomously operated vehicles on a test track, and motorcycle operation functions such as shifting, braking, steering, etc.

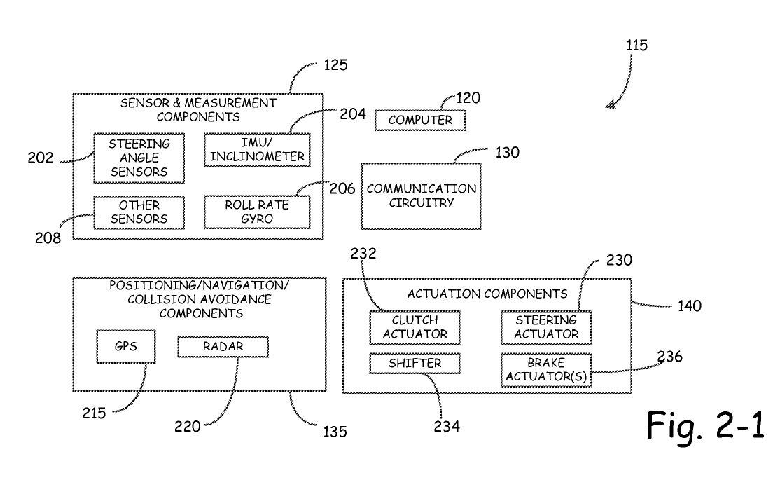

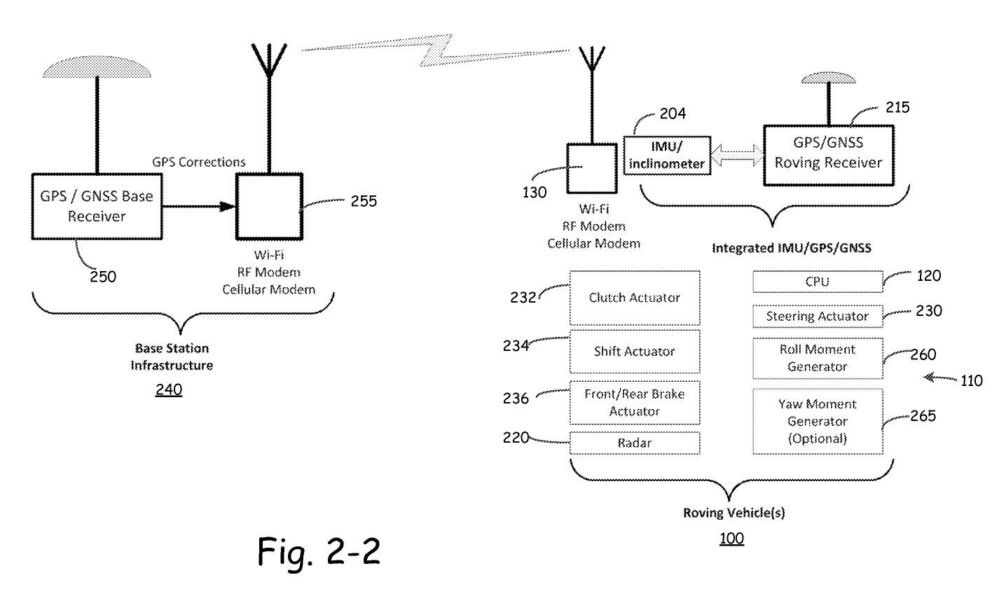

Referring for the moment to FIG. 2-1, shown are further details of example components of navigation and control system 115 in some embodiments. As shown, sensor & measurement components 125 can include steering angle sensor 202, inertial measurement unit (IMU) and optional inclinometer 204, roll rate gyro 206 and other sensors 208. Positioning, navigation & collision avoidance components 135 can include global position system (GPS) or other type of global navigation satellite system (GNSS) receiver 215 and radar 220. Actuation components 140 can include steering actuator 230, clutch actuator 232, shifter 234, and brake actuator(s) 236. Communication circuitry 130 can be any type of communication device (e.g., Wi-Fi, cellular, radio frequency transmitters and receivers, etc.) which provides communication with a remote position such as at a control or base station, communication with other vehicles on the test track, communication with a GPS base station when differential GPS systems are used for improved position determination, etc.

Referring back to FIG. 1, moment generating system 110 serves several unique purposes. First, moment generating system 110 stabilizes motorcycle 100 at zero and low speeds (in the capsize regime) using a sensor-driven, computer controlled reaction wheel/moveable mass system. The reaction wheel 150, which is of a mass representative of a “typical” motorcycle rider's upper body mass, can be spun about an axle or axis 160 and is accelerated or decelerated by a drive motor 155 having a brake or regenerative energy absorber 302 (shown in FIGS. 3-1 through 3-3) to provide stabilizing roll moments 102 (moment about the axis 102′ tangent to motorcycle travel) in response to transient roll disturbances to which the motorcycle is subject through the roll moment created by the acceleration or deceleration of the reaction wheel. The reaction wheel and other components of moment generating system 110 are controlled by a reaction wheel controller 112 in some embodiments. In exemplary embodiments, but not necessarily in all embodiments, if the reaction wheel is also provided the capability to rotate about the yaw axis 103′, stabilizing yaw moments 103 can also be supplied to the motorcycle to improve roll stability at low speeds. In some exemplary embodiments, yaw moment generator or actuator 165 rotates reaction wheel 150 about vertical axis 170 to create a yaw moment. If the yaw and roll mechanisms are mounted on another mechanism which provides rectilinear motion in the motorcycle lateral axis (represented by axis 104′ in the illustrated 3-dimensional coordinate system, but being normal to the plane defined by axes 102′ and 103′ in a 2-dimensional representation), the mass of the reaction wheel and yaw mechanism can be moved laterally, creating a mechanism to stabilize the motorcycle 100 when it is subjected to persistent roll disturbances. The sensor suite 125 used in the capsize mode includes a roll rate gyro 206 and an inclinometer 204 measuring vehicle roll angle.

At zero or low speeds, referred to here as the capsize mode or regime, the moments imparted on a motorcycle through the use of the handlebar can stabilize the motorcycle over only a small space of initial conditions and transient disturbances. A robust control strategy requires that substantial stabilizing moments be applied to the motorcycle so that the motorcycle remains upright. Several exemplary embodiments can be used to provide this substantial stabilizing moment in response to transient disturbances.

Referring now to FIG. 2-2, shown is another example of infrastructure and on-board equipment which can be used to operate a motorcycle or other vehicle autonomously at a test facility. As shown, a motorcycle or other roving vehicle 100 includes moment generating system 110, which is illustratively shown as a roll moment generator 260 and a yaw moment generator 265. As discussed above, the roll moment generator 260 can be used in producing a yaw moment, and could therefore be considered to be part of yaw moment generator 265 in some embodiments. Other components discussed above with reference to FIG. 2-1 are also shown and are not discussed here. An IMU/inclinometer 204 and a GPS receiver 215 (for example a differential GPS receiver) are included, and can be in the form of an integrated IMU/GPS or IMU/GNSS system or device. Communication circuitry 130 in the form of Wi-Fi circuitry, an RF modem, a cellular modem, etc., communicates with communication circuitry 255 at a base station 240 to receive differential positioning signals from base receiver 250 to increase the accuracy of the positioning receiver 215 on motorcycle 100.

Accurately guided autonomous vehicles can be used to precisely follow a specified trajectory (speed, position, acceleration, and optionally roll angle depending upon the operating regime). Using centimeter-accurate GPS as a position measurement system, a riderless motorcycle can repeatedly follow a specified trajectory, which facilitates the generation of durability data which exhibits low variance and few outliers.

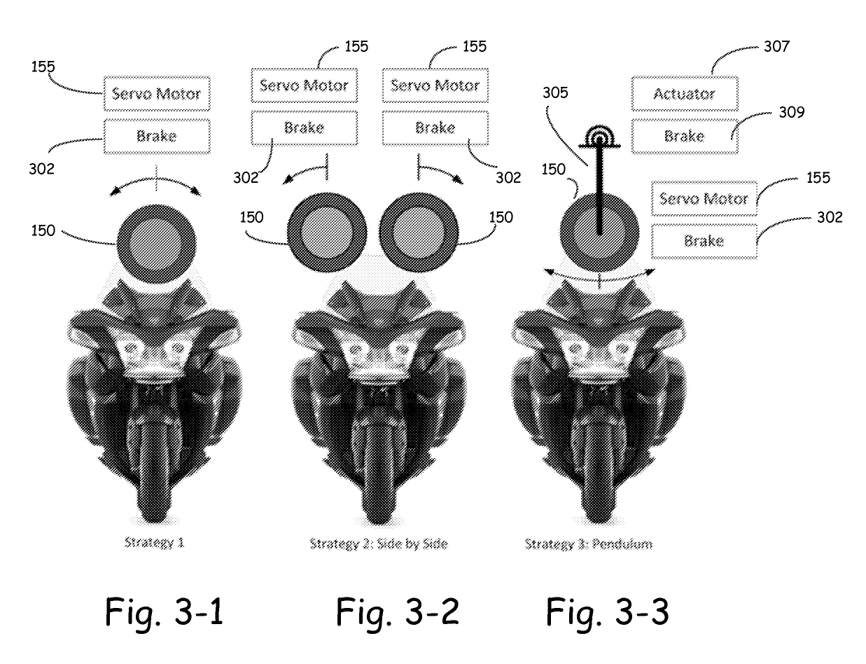

In a first embodiment represented diagrammatically in FIG. 3-1, moment generating system 110 includes a single nominally stationary or slowly moving reaction wheel 150 which is accelerated or decelerated using motor 155 and/or brake 302 to create a stabilizing roll moment 102 (shown in FIG. 1). In this embodiment, a single reaction wheel 150 is driven by an electric, hydraulic or other type of servo motor 155 as a mechanism to impart the stabilizing roll moment and/or to reject a transient roll disturbance (e.g., such as a wind gust, a lateral force applied to the motorcycle, etc.). The motor 155 is configured to rotate reaction wheel 150 in either of two directions, and thereby generates torque in either of the two directions. A linear quadratic optimal controller or other optimal control technique is used to keep the nominal speed of the motor at zero to maximize the available moment provided by the servo motor needed to compensate for the next transient roll disturbance.

In a second embodiment represented diagrammatically in FIG. 3-2, moment generating system 110 includes a pair of reaction wheels 150. In this embodiment, motor 155 is a pair of motors used to spin the pair of reaction wheels at a nominal speed in opposite rotational directions, with external or other brakes or regenerative energy absorbers 302 used to decelerate one or the other of the reaction wheels to generate the desired roll moment in the necessary direction. Generally, a brake can impose a much higher transient moment on a spinning inertia than can a servo motor, thus facilitating greater roll moments in a shorter period of time. Once the braking event is complete, the braking motor accelerates its reaction wheel back to the nominal rotational rate in preparation for a forthcoming roll disturbance.

In a third embodiment shown diagrammatically in FIG. 3-3, a single reaction wheel 150 is suspended from an actuated pendulum 305 to provide a roll moment to the motorcycle to counteract roll disturbances. The roll moment can be provided purely by the pendulum motion of the mass 150, and a motor 155 for rotation of the mass 150 and a brake 302 for decelerating rotation of mass 150 is not required in all embodiments. However, in other embodiments, the reaction wheel 150 is both rotated by a motor 155 (FIG. 1) and moved by an actuator 307 of the actuated pendulum 305 such that both mechanisms contribute to the roll moment generation. Actuator 307 and pendulum brake 309 are used to accelerate and decelerate the pendulum motion. Like the embodiment shown in FIG. 3-1, in FIG. 3-3 the reaction wheel can be rotated in both directions to control the direction of the roll moment.

Should the motorcycle be subject to persistent roll disturbances (mass imbalance about the vertical axis 103′, steady side wind, etc.), the roll and yaw moment generation system 110 can be translated laterally to compensate for this persistent disturbance. The offset of this mass from the motorcycle vertical axis creates a roll moment which can compensate for the persistent roll moment to which the motorcycle is subject. Referring now to FIGS. 4-1, 4-2, 4-3 and 5, shown are example embodiments of moment generation systems 110 which include lateral translation components for moving the reaction wheel(s) laterally. In one embodiment, a fixed frame 405 supports a translation frame 410, which in turn supports (including supporting through coupling with other components) the reaction wheel 150. A rectilinear actuator 505, or other type of actuator, moves the translation frame and reaction wheel laterally along axis 104′. With the ability to generate a roll moment 102 and a yaw moment 103 (using actuator 165 shown in FIG. 1), and with the ability to translate those moments laterally relative to the roll axis of the motorcycle, compensation for persistent roll disturbances and/or non-uniform mass distributions about the motorcycle vertical axis 103′ can be implemented. In some embodiments, a support frame 407 is included which supports the translation frame 410 in a manner which provides vertical movement or adjustment of the translation frame relative to the fixed frame 405, but inclusion of support frame 407 and/or vertical movement of the translation frame (and reaction wheel) is not required in all embodiments.

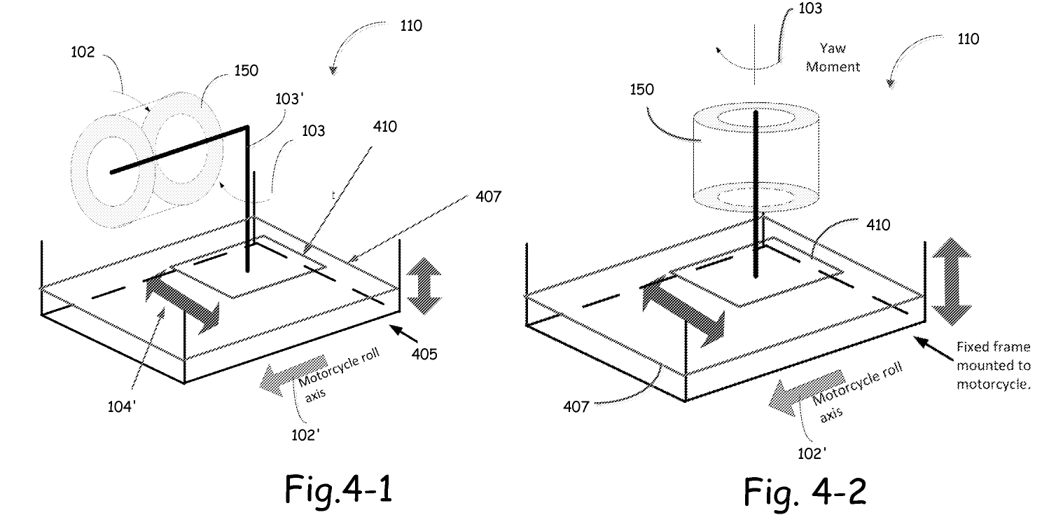

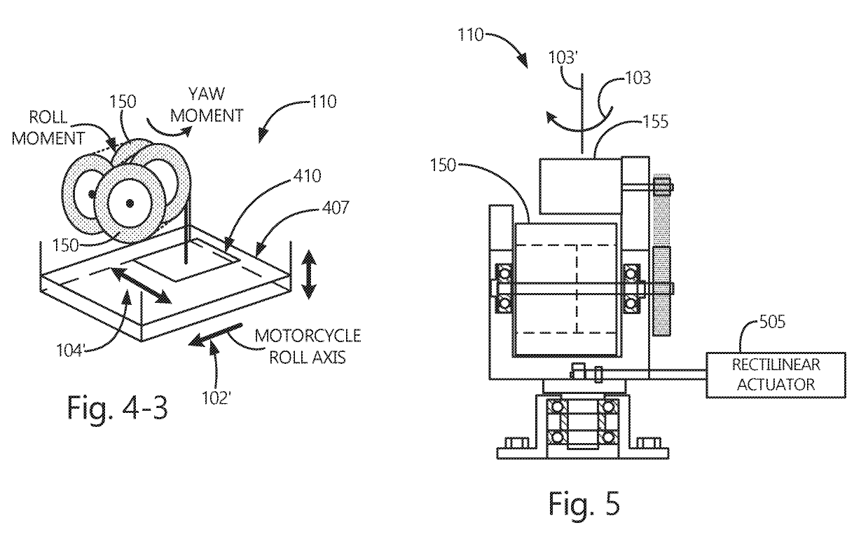

As discussed above, moment generation system 110 can also include a yaw moment generation system. This can be implemented by rotating the reaction wheel frame (e.g., frame 410 or 407 and its components around the vertical axis 103′. Yaw moment actuator 165 (shown in FIG. 1) can be used for such rotation. The axis of the reaction wheel remains parallel to the ground, but rotates relative to the direction of travel. In exemplary embodiments, the frame is rotated so that the axis through the bearings which support the reaction wheel rotate towards the vehicle lateral axis from the vehicle longitudinal axis. The yaw moment is generated by accelerating (in rotation about the vertical axis) the frame which holds the reaction wheel and the motor which drives the reaction wheel about the vertical axis. The reaction wheel can be stationary during this rotation. The angular acceleration of that mass is what generates the yaw moment. FIG. 4-3 diagrammatically illustrates reaction wheel 150 being accelerated rotationally about the vertical or yaw axis to create such a yaw moment.

FIG. 4-2 illustrates a reaction wheel configuration for an alternative yaw moment generator configuration where the reaction wheel has been moved to be on the vertical axis instead of a horizontal axis.

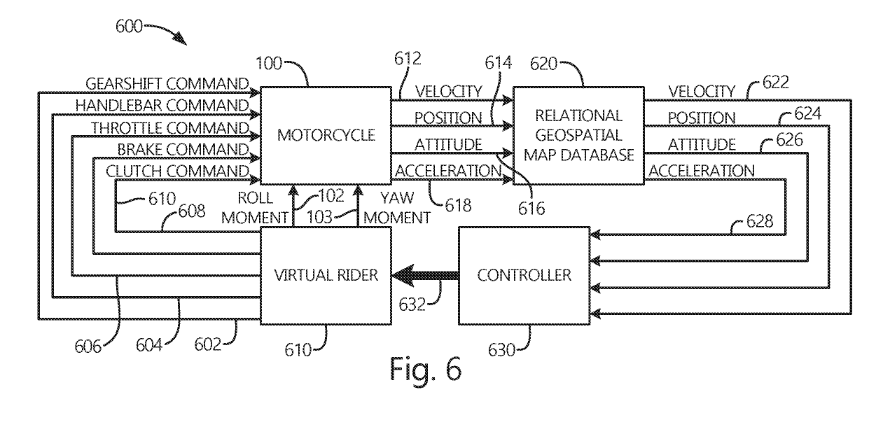

Referring now to FIG. 6, shown in block diagram form is a virtual test rider system 600 using the concepts disclosed above with reference to FIGS. 1-5. A virtual rider, which includes moment generation system 110 and other components such as controllers, actuators, etc. as discussed above, generates a gearshift command 602, a handlebar command 604, a throttle command 606, a brake command 608 and a clutch command 610 to control corresponding components on motorcycle 100. The handlebar command controls a steering angle to guide the motorcycle on an intended path. Sensors then provide outputs such as velocity 612, position 614, attitude 616, and acceleration 616. Using a relational geospatial map database and corresponding processing circuitry, it can be determined whether the position, speed, etc. of the motorcycle is deviating from the desired state, and error outputs can be generated. By way of example, in FIG. 6, a velocity error 622, a position error 624, an attitude error 626 and an acceleration error 628 can all be generated, though all are not required in every embodiment. A controller 630 receives these error signals or values and generates commands 632 which cause virtual rider 610 to compensate with values of commands 602, 604, 606, 608 and/or 610, as well as to compensate by generating a roll moment 102 and/or a yaw moment 103. Also, controller 630 can generate commands 632 to cause virtual rider to generate roll or yaw moments for purposes of introduction of disturbances or simulation of human driver behavior.

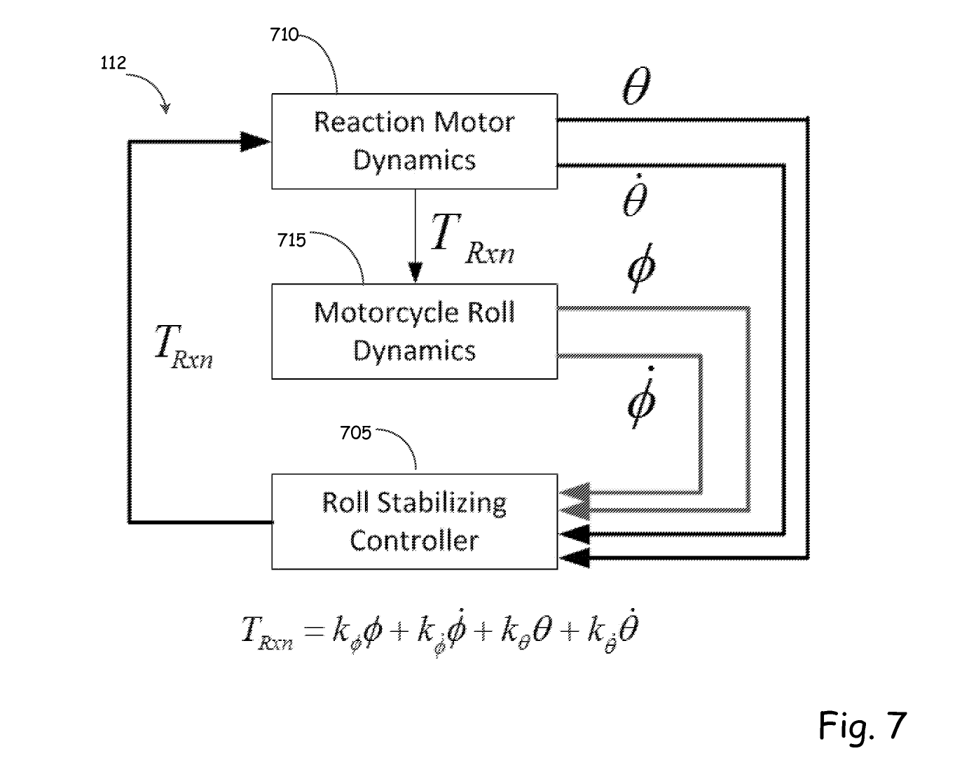

Referring now to FIG. 7, shown is a reaction wheel control scheme implemented by reaction wheel controller 112 (shown in FIG. 1) in some embodiments to keep the driven reaction wheel nominally at zero speed and the motorcycle upright. Both angle and angular rate data are used to stabilize the motorcycle and minimize reaction wheel speed. Reaction wheel controller 112 uses a linear quadratic regulator (LQR) or other optimal controller to generate a torque control signal T_{Rxn} which is used to control the reaction motor 155. In FIG. 7, reaction motor dynamics 710 represents reaction motor 155 in combination with an inclinometer 204 which provides as outputs the angle θ and the rate of rotation θ-dot of the reaction motor 155. Motorcycle roll dynamics 715 represents motorcycle 100 in combination with the inclinometer 204 which provides as outputs the sensed roll angle φ and the sensed roll angle rate φ-dot of the motorcycle. An equation which can be used by the LQR controller to generating torque control signal T_{Rxn} is shown in FIG. 7, wherein k_{φ}, k_{φ′}, k_{θ} and k_{θ′} are constants.

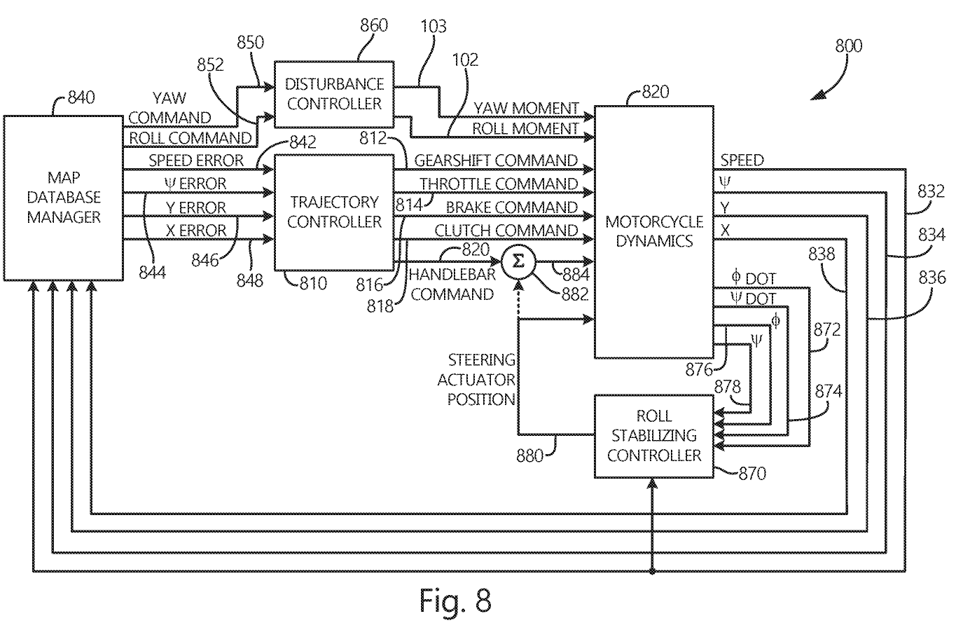

Referring now to FIG. 8, shown in block diagram form is a control system 800 using both inner-loop roll stabilization control and outer loop control to guide the motorcycle around a test track and through various stages. A trajectory controller 810 generates a gearshift command 812, a throttle command 814, a brake command 816, a clutch command 818 and a handlebar angle command 818 in order to cause the motorcycle to drive around the test track in accordance with a map database. Disturbance controller 860 includes moment generation system 110 and receives yaw and roll commands 850 and 852 from a map database manager 840. Map database manager 840 can also implement portions of moment generation system 110, such as portions of reaction wheel control 112 which can be distributed between map database manager and disturbance controller 860. In response to yaw and roll commands 850 and 852, disturbance controller 860 uses the reaction wheel features discussed above to generate yaw moment 103 and/or roll moment 102. At very low speeds in the capsize mode of operation, these moments are used to stabilize the motorcycle and keep it upright. After the motorcycle achieves sufficient speed to be completely or primarily stabilized through steering, yaw and roll commands 850 and 852 are used to introduce disturbances for purposes testing durability and performance by simulating the body positioning and movements of a typical human driver for example when cornering), by introducing large disturbances to simulate difficult conditions (e.g., wind gusts), etc.

Motorcycle dynamics block 830 represents both motorcycle 100 and the sensors which measure speed 832, roll angle phi φ (measured by an inclinometer or two GPS antennas mounted along the lateral axis of the vehicle), and positions Y 836 and X 838, and thus is a representation of what motorcycle 100 is physically doing on the road. These output signal values are provided in an outer feedback loop to map database manager 840 which then calculates and outputs a speed error signal 842 based on the differential between the commanded speed and the measured speed, a roll angle error signal 844 based on the differential between the intended roll angle and the measured roll angle, and position Y error signal 846 and position X error signal 848 based on the differences between the measured position values and the intended position values. Trajectory controller 810 then uses these error signals in a closed loop feedback system to adjust signals 812, 814, 816, 818 and 820 accordingly.

System 800 also implements a stability feedback system for controlling steering in the higher speed weave mode of operation where stability can be achieved without the required use of disturbance controller 860. In this mode of operation, a sensed or measured yaw angle rate iv-dot (psi-dot) 872 of the motorcycle, a sensed or measured roll angle rate φ-dot (phi-dot) 874 of the motorcycle, a sensed or measured roll angle φ (phi) 876 of the motorcycle, and a sensed or measured angle δ (delta) 878 of the front frame (handlebars) with respect to the rear frame (i.e., the angle of the steered front wheel with respect to the main motorcycle fame) are fed through a roll stabilization controller 870 which generates a feedback steering or handlebar actuator position signal 880. Yaw angle rate ψ-dot 872 and roll angle rate φ-dot 874 are measured by an IMU (e.g., IMU 204 in FIG. 2). Angle δ (delta) 878 can be measured by an encoder or other sensor capable of measuring rotation (e.g., a potentiometer) on the motorcycle triple clamp. The feedback handlebar actuator signal 880 is combined with the commanded handlebar signal 820 at a summation node 882 to produce a feedback adjusted handlebar command signal 884 which will cause the steering actuator to adjust handlebar position to generate small moments that stabilize the motorcycle in the weave mode of operation. The motorcycle speed 832 is also a parameter to compute the desired roll angle of the motorcycle.

Roll stabilizing controller 870 determines what the handlebar force should be to keep the motorcycle at the proper roll angle. If the motorcycle is going in a straight line, the roll angle should be zero (as measured from a vertical axis). If the motorcycle is going around a corner or a curve, the desired roll angle is a function of speed and the curvature of the road. For a fixed speed, the greater the curvature (equivalently, the smaller the radius), the greater the roll angle should be so that the roll moment on the motorcycle due to centripetal acceleration on that motorcycle going around the corner is balanced by the gravity moment produced by the roll angle of the motorcycle. Nominally, if those two balance around the corner, neutral handling is achieved.

Yaw angle rate ψ-dot 872 in combination with speed 832 gives an estimate of curvature, from which the centripetal acceleration is computed. That centripetal acceleration times the height of the center of gravity (CG) of the motorcycle times the mass of the bike times the cosine of the roll angle is the roll moment due to centripetal acceleration. The height of the CG times the motorcycle mass time gravity times the sine of the roll angle is the roll moment due to gravity. Controller 870 generates signal 880 to adjust the roll angle to achieve balance through a corner.

Disclosed embodiments provide great potential in the testing of motorcycles, ATVs, scooters, and other similar vehicles. As discussed, motorcycle durability schedules more frequently “test the rider” than “test the bike.” The difficult riding conditions used for durability testing often lead to excessive rider fatigue, rider injury, workmen's compensation claims, early retirement, and difficulty recruiting test riders. The autonomous motorcycle (under a reasonable operating envelope) will not be affected by rain and other inclement weather. Autonomous motorcycle control moves the rider out of the equation, thereby eliminating the difficulties associated with durability test riders.

Motorcycle performance can be potentially better evaluated at the edges of the performance envelope with an autonomous controller than with a human operator for a number of reasons. At the edge, the vast percentage of a rider's attention is used trying not to crash, leaving only a small portion of mental capacity used to report back how the motorcycle feels or handles. The efficacy of the rider as a subjective evaluation tool is low under these conditions. At the edge, the repeatability of both the trajectory of the motorcycle and the disturbances input to the motorcycle are poor with a human rider, making comparison of two or more test runs difficult at best, and impossible at the worst. Likewise, the efficacy of the rider as a means to generate objective, repeatable data for evaluation and analysis is also low under these conditions. There are some conditions which motorcyclists encounter which are likely to cause test riders injury; ethically, a test rider can't be asked to test the motorcycle in those high-risk conditions. For these conditions, an autonomous motorcycle may be the only option by which those conditions can be tested.

By automating these processes, the repeatability for both performance and durability testing is significantly improved. Moreover, for performance testing, precise levels of roll and yaw moments can be repeatable and accurate yaw moments imparted on a vehicle at a desired location, speed and orientation on a test facility to a significantly higher degree than can that done by a human rider. This ability to replicate test conditions greatly accelerates the development and validation process.

The advent of dual frequency, carrier phase DGPS which can be integrated with six-axis inertial measurement units facilitates the accurate measurement and control of position, speed, and orientation of the motorcycle as it traverses a test track for durability testing. Automation of that process keeps riders from taking the “easy way” around particularly difficult paths, and ensures that the data collected by the test is based on the desired test trajectory, not a trajectory which is less difficult for the test rider. For performance testing the motorcycle can be operated “at the limit” without putting a test rider at risk of a crash or injury.

At all speeds, the ability to control and stabilize a motorcycle without the use of outriggers provides a mechanism for higher fidelity testing. The use of outriggers to prevent a motorcycle from overturning affects the vehicle dynamics (adds roll and yaw inertia, creates unwanted yaw moments when the outrigger touches down, etc.). The use of outriggers has a particularly bad effect on sport bikes which have relatively low yaw and roll inertias.

### APPENDIX ON DATA FLOW FOR MOTORCYLE

Data Flow for Riderless Motorcycle Path Following

1) Measurements for determination of vehicle path

Xglobal—from GPS

Yglobal—from GPS

roll angle—from GPS

heading—from GPS

roll rate—from processor (IMU)

yaw rate—from processor (IMU)

steering angle—from steering sensor

motorcycle lateral velocity—from GPS

steering angle rate—from steering sensor

Steering angle rate and motorcycle lateral velocity are derived as follows:

1)

$$steering rate = \frac{steerangle ( {t}_{tot} ) - steerangle ( t )}{Δ t}$$

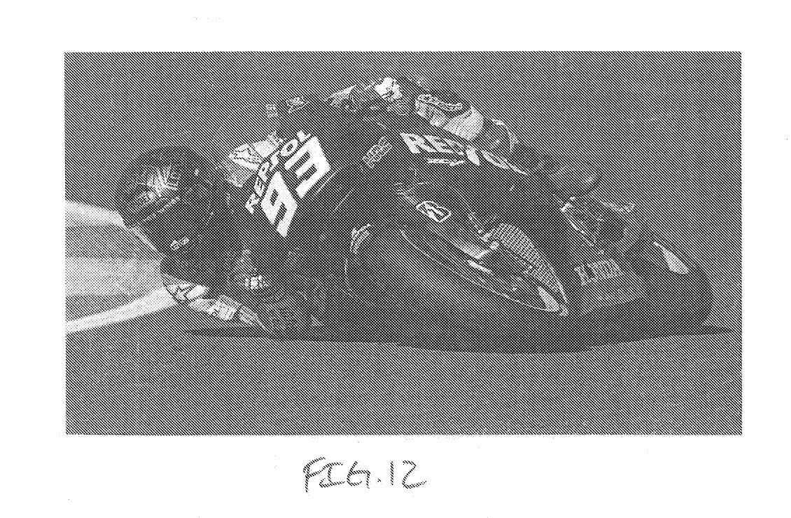

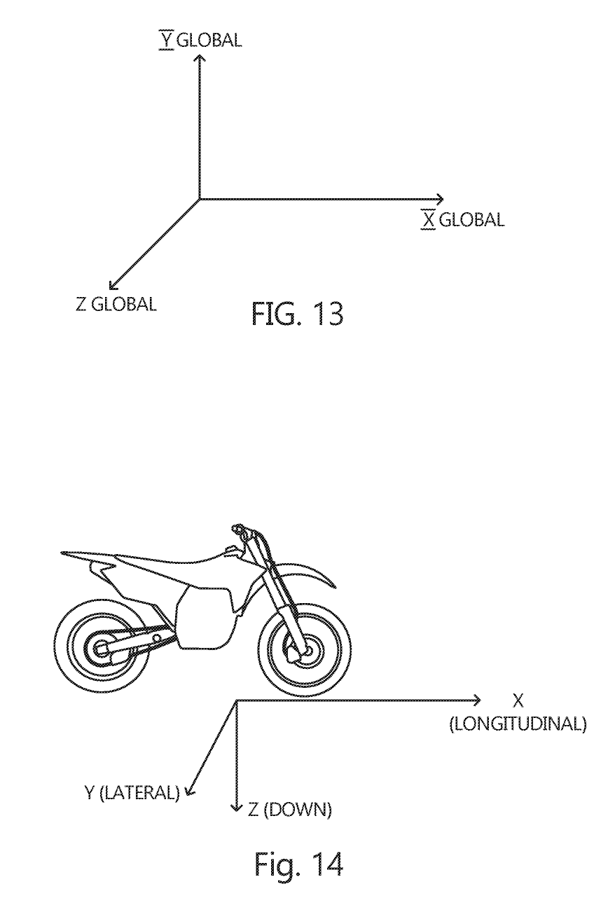

2) motorcycle lateral velocity=with reference to coordinate frames (FIG. 13), and motorcycle coordinate frame (FIG. 14)

Yaw rate is clockwise (looking down), so positive yaw rate in vehicle coordinates is negative yaw rate in global coordinates.

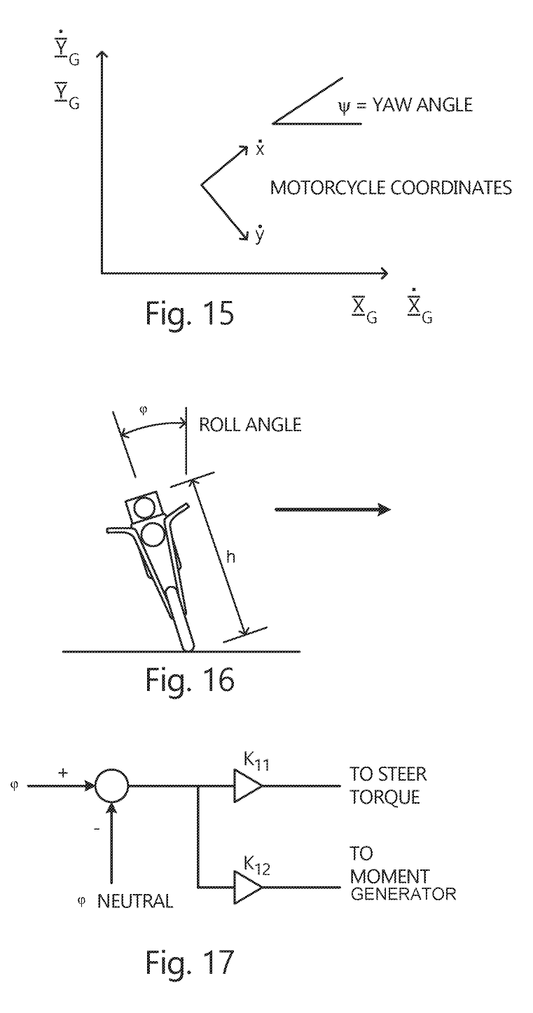

To determine motorcycle lateral velocity in body coordinates from GPS in Global coordinates (FIG. 15)

where:

$$\dot{X} = {\dot{X}}_{G} cos ( ψ ) + {\dot{Y}}_{G} sin ( ψ ) = [ \begin{matrix}cos ( ψ ) & sin ( ψ ) \\ sin ( ψ ) & cos ( ψ )\end{matrix} ]$$

$$\dot{Y} = {\dot{X}}_{G} sin ( ψ ) - {\dot{Y}}_{G} cos ( ψ )$$

Thus, vehicle lateral velocity is computed by

\dot{Y}=\dot{X}_{G} sin(ψ)−\dot{Y}_{G} cos(ψ)

Heading angle ψ comes from the GPS, adjusted to fit the coordinate system.

The system is a six-state system

$$[ \begin{matrix}ϕ \\ δ \\ \dot{Y} \\ \dot{ψ} \\ \dot{ϕ} \\ \dot{δ}\end{matrix} ] = {X}_{-}^{-} .$$

wherein stabilizing feedback takes the form K X⁻

where K is a 6×2 matrix

$$[ \begin{matrix}{K}_{11} & {K}_{12} & … & {K}_{16} \\ {K}_{21} & {K}_{22} & … & {K}_{26}\end{matrix} ]$$

The output is

$$U = [ \begin{matrix}{U}_{1} \\ {U}_{2}\end{matrix} ] = [ \begin{matrix}{K}_{11} & {K}_{12} & … & {K}_{16} \\ {K}_{21} & {K}_{22} & … & {K}_{26}\end{matrix} ] [ \begin{matrix}ϕ \\ δ \\ \dot{Y} \\ \dot{ψ} \\ \dot{ϕ} \\ \dot{δ}\end{matrix} ]$$

U₁=steering torque

U₂=moment applied by the moment generators

K is determined based on state matrices (A, B) and error penalties (Q, R).

K is “optimal” with respect to (Q and R).

Given these six states, four are used to affect the behavior of the motorcycle.

These 4 are

$$[ \begin{matrix} & ϕ & & & \\ & & \dot{Y} & & \\ & & & \dot{ψ} & \\ & & & & \dot{ϕ}\end{matrix} ] = [ \begin{matrix}roll \\ lateral velocity \\ yaw rate \\ roll rate\end{matrix} ]$$

(The steering angle and rate at which the steering rotates are irrelevant for this determination).

Each of the states can be used to affect the system.

1) Roll angle

For neutral roll, mass=m, corner radius=R, yaw rate=\dot{ψ}, motorcycle speed=V, and referring to FIG. 16.

For a neutral roll, the sum of the moments=0

mgh sin φ=mh cos φV²/R

g sin φₙₑᵤₜᵣₐₗ=cos φV²/R

Know R (approximately) from the map database (GPS), then

$$\frac{sin {ϕ}_{neutral}}{cos {ϕ}_{neutral}} = \frac{{V}^{2}}{gR}$$

$${ϕ}_{neutral} = a tan ( \frac{{V}^{2}}{gR} )$$

R has a sign based on road curvature. The sign is used to have neutral left or right.

(If R is difficult,

$$\frac{{V}^{2}}{R} = v ( \dot{ψ} )$$

because \dot{ψ}=V/R

The sign of the yaw rate \dot{ψ} can give insight into the sign of R

$${ϕ}_{neutral} = sign ( \dot{ϕ} ) a tan ( \frac{{V}^{2}}{g abs ( R )} )$$

Refer to feedback scheme of FIG. 17.

2) Roll angle rate

The roll angle rate can be used as a preview to improve transient system performance.

Let φₙₑᵤₜᵣₐₗ(t) be the neutral roll angle at time t.

Let φₙₑᵤₜᵣₐₗ(t+ΔT) be the neutral roll angle at time t+ΔT.

At time (t+ΔT), V (t+ΔT) is known (as part of a trajectory) and the radius of the path is known as R(t+ΔT).

Thus,

$$ϕ ( t + Δ T ) = atan ( \frac{{V}^{2} ( t + Δ T )}{gR ( t + Δ T )} )$$

Therefore, the desired roll rate

$${\dot{ϕ}}_{neutral} = \frac{ϕ ( t + Δ T )}{Δ T}$$

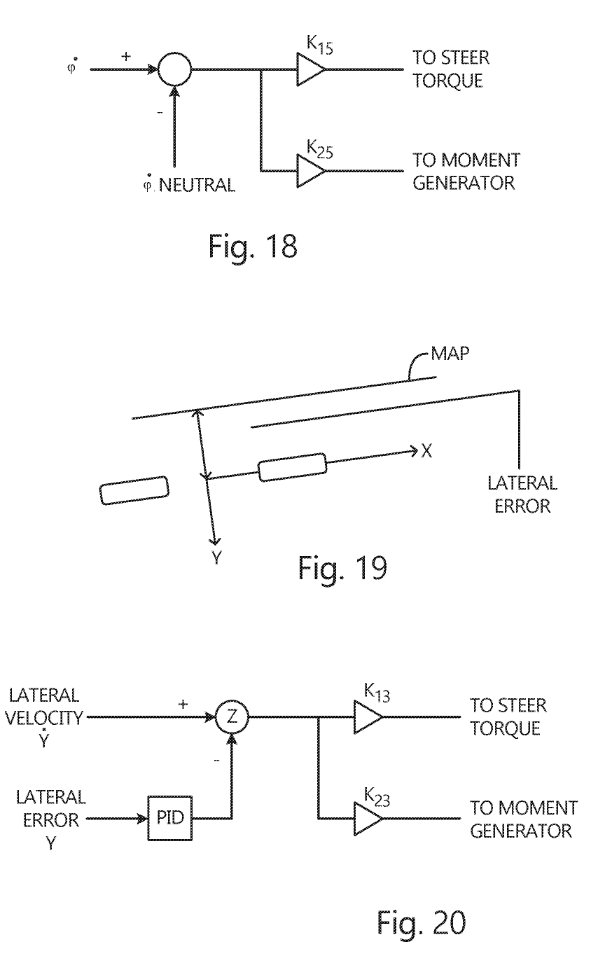

The feedback is then as shown in FIG. 18.

3) Lateral velocity

Feedback is to a velocity state, and the error is a displacement, as shown in FIG. 19.

Because lateral error distance is measured, but direct input into the system is velocity, a PID control driven by lateral distance error may be used as shown in FIG. 20, where gains: P=−2, I=−5 (gains are negative due to coordinate systems)

The integral term on distance error drives the lateral error to zero asymptotically.

4) Yaw Velocity

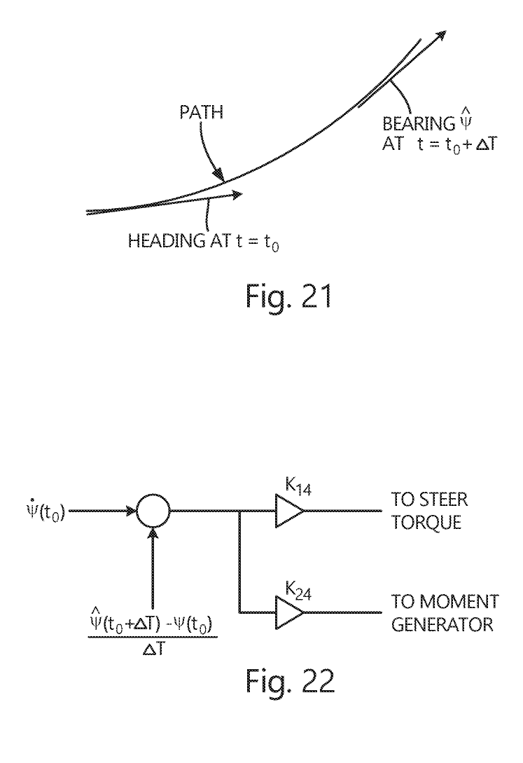

Yaw velocity acts as a path preview. As the motorcycle moves along, the desire is to have it move in the right direction as shown in FIG. 21.

Thus, to have heading ψ(t₀+Δt) starting from heading ψ(t₀), the heading rate is

$$\dot{ψ} ( {t}_{0} ) = \frac{ψ ( {t}_{0} + Δ T ) - ψ ( {t}_{0} )}{Δ T}$$

This is shown in feedback form in FIG. 22.

Although the present invention has been described with reference to preferred embodiments, workers skilled in the art will recognize that changes may be made in form and detail without departing from the spirit and scope of the invention.

What is claimed is:

1. A vehicle control system for use on a roll-unstable wheeled vehicle, the control system comprising:
a moment generator coupleable to the roll-unstable wheeled vehicle and configured to selectively generate a roll moment in either of first and second directions about a vehicle longitudinal axis corresponding to forward motion of the roll-unstable wheeled vehicle, wherein the moment generator comprises a reaction wheel and a motor configured to rotationally accelerate or decelerate the reaction wheel; and
a control system operably coupleable to the moment generator and configured to control the moment generator to selectively impart roll moments on the roll-unstable wheeled vehicle.

2. The vehicle control system of claim 1, wherein the control system is further configured to stabilize the roll-unstable wheeled vehicle or to selectively introduce destabilizing disturbances on the vehicle.

3. The vehicle control system of claim 1, wherein the motor further comprises a brake configured to selectively rotationally decelerate the reaction wheel and thereby selectively impart the roll moments on the roll-unstable wheeled vehicle.

4. The vehicle control system of claim 3, wherein the motor is configured to selectively rotationally accelerate or decelerate the reaction wheel in both of two directions, thereby selectively generating the roll moments in either of the two directions.

5. The vehicle control system of claim 1, wherein the moment generator further comprises a second reaction wheel and a motor configured to rotationally accelerate or decelerate the second reaction wheel in a direction opposite the first reaction wheel, and wherein the control system is configured to control rotational acceleration or deceleration of both of the first and second reaction wheels to thereby selectively generate the roll moment in either of the first and second directions.

6. The vehicle control system of claim 1, wherein the moment generator comprises an actuated pendulum to selectively generate the roll moment in either of the first and second directions.

7. The vehicle control system of claim 1, wherein the moment generator comprises a roll moment generator configured to impart the roll moment on the roll-unstable wheeled vehicle in the vehicle longitudinal axis, and a yaw moment generator configured to impart a yaw moment on the roll-unstable wheeled vehicle in a vehicle vertical axis.

8. The vehicle control system of claim 7, wherein the moment generator comprises the reaction wheel configured to be rotationally accelerated or decelerated about the vehicle longitudinal axis, the motor configured to rotationally accelerate or decelerate the reaction wheel about the vehicle longitudinal axis, a support frame which supports the reaction wheel and the motor, and an actuator configured to rotate the reaction wheel, the motor, and the support frame about the vehicle vertical axis, perpendicular to the vehicle longitudinal axis, wherein angular acceleration of the reaction wheel, the motor, and the support frame about the vehicle vertical axis imparts the yaw moment upon the roll-unstable wheeled vehicle about the vehicle vertical axis, and thereby the yaw moment generator comprises the reaction wheel, the motor, the support frame and the actuator.

9. The vehicle control system of claim 7, wherein the moment generator comprises the reaction wheel configured to be rotationally accelerated or decelerated about the vehicle longitudinal axis, the motor configured to rotationally accelerate or decelerate the reaction wheel about the vehicle longitudinal axis, and a lateral translation mechanism configured to move the reaction wheel laterally relative to the vehicle longitudinal axis to generate moments to compensate for persistent roll disturbances or non-uniform mass distributions about the vehicle vertical axis.

10. The vehicle control system of claim 9, wherein the lateral translation mechanism comprises a fixed frame coupleable in a fixed position relative to the roll-unstable wheeled vehicle, a translation frame supporting the reaction wheel, and an actuator configured to move the translation frame and reaction wheel with respect to the fixed frame and laterally relative to the vehicle longitudinal axis.

11. The vehicle control system of claim 1, wherein the moment generator comprises the reaction wheel and the motor configured to rotationally accelerate or decelerate the reaction wheel, and wherein the control system comprises an optimal controller configured to maintain the slowest rotational velocity of the reaction wheel in order to provide maximum torque availability from the motor for compensation of transient roll disturbances on the roll-unstable wheeled vehicle.

12. The vehicle control system of claim 1, wherein the moment generator is configured to be coupled to a motorcycle to provide control of the motorcycle.

13. The vehicle control system of claim 1, wherein the moment generator further comprises a yaw moment generator, and wherein the control system is configured to control the yaw moment generator to selectively impart a yaw moment on the roll-unstable wheeled vehicle in a vehicle vertical axis to stabilize the roll-unstable wheeled vehicle or to introduce destabilizing disturbances on the roll-unstable wheeled vehicle.

14. The vehicle control system of claim 1, wherein the moment generator is enabled when the roll-unstable wheeled vehicle has a zero speed in the forward direction.

15. The vehicle control system of claim 14, wherein the moment generator is disabled when the roll-unstable vehicle has a speed greater than zero in the forward direction.

16. A method of providing control assist of a roll-unstable wheeled vehicle, the method comprising:
accelerating or decelerating a reaction wheel coupled to the roll-unstable wheeled vehicle in either of first and second directions about a vehicle longitudinal axis corresponding to forward motion of the roll-unstable wheeled vehicle; and
controlling the reaction wheel acceleration or deceleration to selectively impart roll moments on the roll-unstable wheeled vehicle relative to the vehicle longitudinal axis to stabilize the roll-unstable wheeled vehicle or to introduce destabilizing disturbances on the roll-unstable wheeled vehicle.

17. The method of claim 16, wherein controlling the reaction wheel further comprises selectively imparting a yaw moment on the roll-unstable wheeled vehicle relative to a vehicle vertical axis to stabilize the roll-unstable wheeled vehicle or to introduce destabilizing disturbances on the roll-unstable wheeled vehicle.

18. The method of claim 16, wherein controlling the reaction wheel further comprises selectively moving the reaction wheel laterally relative to the vehicle longitudinal axis to impart moments on the roll-unstable wheeled vehicle.

19. The method of claim 16, wherein controlling the reaction wheel further comprises selectively moving the reaction wheel in a pendulum movement to impart moments on the roll-unstable wheeled vehicle.

20. The method of claim 16, and further comprising controlling the reaction wheel to maintain a substantially vertical position of the roll-unstable wheeled vehicle when the roll-unstable wheeled vehicle has zero speed in the forward direction.

21. The method of claim 16, wherein accelerating or decelerating the reaction wheel is performed when the roll-unstable vehicle has zero speed in the forward direction.

22. The method of claim 16, wherein accelerating or decelerating the reaction wheel is halted when the roll-unstable vehicle has a non-zero speed in the forward direction.

23. The method of claim 17, wherein destabilizing disturbances are introduced to assist turning the roll-unstable wheeled vehicle when the roll-unstable vehicle enters a turning configuration at a speed greater than a predetermined speed in a forward direction.

24. The method of claim 17, wherein selectively imparting a yaw moment to stabilize the roll-unstable wheeled vehicle is performed when the roll-unstable wheeled vehicle has a speed in the forward direction lower than a predetermined speed.

25. The method of claim 17, wherein selectively imparting a yaw moment to stabilize the roll-unstable wheeled vehicle is performed when the roll-unstable wheeled vehicle has zero speed in the forward direction.

26. The method of claim 17, wherein selectively imparting a yaw moment to destabilize the roll-unstable wheeled vehicle is performed when the roll-unstable wheeled vehicle has a speed in the forward direction greater than a predetermined speed, and the roll-unstable vehicle enters a turning configuration.

27. The method of claim 17, wherein control assist of the roll-unstable wheeled vehicle may be selectively turned on and off.

28. A method of providing control assist to a roll-unstable wheeled vehicle operated by a driver, the method comprising:
accelerating or decelerating a reaction wheel coupled to the roll-unstable wheeled vehicle in either of first and second directions about a vehicle longitudinal axis corresponding to forward motion of the roll-unstable wheeled vehicle; and
controlling the reaction wheel acceleration or deceleration to selectively impart roll moments on the roll-unstable wheeled vehicle relative to the vehicle longitudinal axis to stabilize the roll-unstable wheeled vehicle or to introduce destabilizing disturbances on the roll-unstable wheeled vehicle;
wherein stabilizing moments are selectively imparted when the roll-unstable wheeled vehicle has a speed in the forward direction at or lower than a predetermined speed, and stabilizing moments are not imparted when the roll-unstable wheeled vehicle has a speed greater than the predetermined speed in the forward direction.

29. The method of claim 28, wherein the predetermined speed in the forward direction is zero.

30. The method of claim 28, wherein destabilizing moments are selectively imparted when the roll-unstable wheeled vehicle has a speed greater than the predetermined speed in the forward direction, and destabilizing moments are not imparted when the roll-unstable wheeled vehicle has a speed in the forward direction at or lower than the predetermined speed.

31. The method of claim 30, and further comprising selectively turning control assist of the roll-unstable wheeled vehicle on and off.

32. A motorcycle, comprising:
a frame having an engine, a pair of wheels, a seat, and handlebars mounted to the frame; and
a moment control system mounted to the frame, comprising:
a moment generator coupled to the motorcycle and configured to selectively generate a roll moment in either of first and second directions about a motorcycle longitudinal axis corresponding to forward motion of the motorcycle, wherein the moment generator comprises a reaction wheel and a motor configured to rotationally accelerate or decelerate the reaction wheel; and
a control system operably coupleable to the moment generator and configured to control the moment generator to selectively impart roll moments on the motorcycle to stabilize the roll-unstable wheeled vehicle or to selectively introduce destabilizing disturbances on the motorcycle.

33. The motorcycle of claim 32, wherein the moment generator is mounted to the frame so as to allow a rider to operate the vehicle in a normal operating position.
